(19) United States
(12) Patent Application Publication
(10) Pub. No.: US 2026/0031380 A1
(43) Pub. Date: Jan. 29, 2026

(54) OXIDIZED SULFUR HETEROCYCLES FOR NON-AQUEOUS REDOX FL0W BATTERIES

(71) Applicant: ExxonMobil Technology and Engineering Company, Spring, TX (US)

(72) Inventors: Satish Bodige, Wayne, NJ (US); Divyaraj Desai, Stewartsville, NJ (US); Jordan Metz, Doylestown, PA (US); Ross Mabon, Whitehall, PA (US); Heather A. Elsen, Nazareth, PA (US)

(73) Assignee: ExxonMobil Technology and Engineering Company, Spring, TX (US)

(21) Appl. No.: 19/090,174

(22) Filed: Mar. 25, 2025

Related U.S. Application Data
(60) Provisional application No. 63/570,175, filed on Mar. 26, 2024.

(51) Int. Cl. H01M 8/18

(52) U.S. Cl. CPC H01M 8/188; H01M 2300/0002; H01M 2300/0017

(57) ABSTRACT

Disclosed herein are a variety of systems, compositions, and methods for reversibly storing electrical energy in a redox flow battery with a unit cell potential equal to or greater than 3.0 volts (V). The system may include an electroactive redox molecule, a positive section, and a negative section. The electroactive redox molecule may comprise an anolyte moiety comprising a multi-ring conjugated system comprising at least one sulfone group, wherein an anolyte reaction occurs at a cell potential less than −1.50 V. The positive section may comprise a first metal electrode in contact with the electroactive bipolar redox molecule and a supporting electrolyte dissolved in a solvent. The negative section may comprise a second metal electrode in contact with the electroactive bipolar redox molecule and additional electrolyte dissolved in additional solvent.

### CROSS-REFERENCE TO RELATED APPLICATION

This is a Non-Provisional Application claiming priority to U.S. Provisional Patent Application No. 63/570,175 filed Mar. 26, 2024, the entire disclosure of which is incorporated herein by reference.

### FIELD

This disclosure relates to the oxidation of sulfur-containing heterocyclic molecules to enable their use as non-aqueous redox flow battery electrolytes.

### BACKGROUND

The intermittency of renewable energy from wind and solar necessitates a large-scale deployment of long duration energy storage technologies. By providing the unique advantage of decoupled energy and power capacity, redox flow batteries are capable of storing large amounts of energy during periods of excess generation and supplying during excess electricity load.

The stored electrochemical energy in a redox flow battery can be efficiently converted from electrical energy to chemical energy. The chemical reactions involve changes in the valence of dissolved electroactive species: a catholyte and an anolyte. However, the electroactive species may also be otherwise dispersed in the fluid phase in the form of a slurry or emulsion to achieve a high loading, and consequently, a high energy density. The storage capacity is determined by the volume of fluid electrolyte stored in tanks and the volume of fluid of electrolyte recirculated past an electrochemical unit cell responsible for through parallel plates between current collectors and an ion selective membrane. The energy storage capacity may be determined by the number of moles of redox-active species, while the power output is determined by the active area of the electrochemical stack. Therefore, redox flow batteries have the unique benefit of independent power and energy scaling. This attribute is particularly advantageous for longer duration energy storage, wherein the cost of storage is primarily driven by the fluid cost.

Typical redox flow battery system includes one or more redox-active species, an optional supporting electrolyte and an optional solvent and a stack comprising one or more electrochemical cells. The electrochemical stack comprises current collectors, optional high-surface area electrodes, optional ion-selective membranes or porous separators and an optional fluid transport device, such as a peristaltic pump.

Most redox flow batteries utilize dissimilar redox species at the anode electrolyte (anolyte) and at the cathode electrolyte (catholyte). This results in a concentration gradient of each redox-active species on either side of the ion-transport membrane or porous separator, resulting in a steady flux in the diffusion of the redox-active species, i.e., anolyte into the catholyte half-cell and vice versa. This diffusive redox-active species flux is referred to as redox crossover and can result in considerable loss of battery capacity during typical operation. By comparison, a symmetric redox flow battery system leverages multivalent compounds, or elements, and is not irreversibly susceptible to crossover-induced failure.

### SUMMARY

Disclosed herein is an example system for energy storage including an electroactive redox molecule comprising an anolyte moiety comprising a multi-ring conjugated system comprising at least one sulfone group, wherein an anolyte reaction occurs at a cell potential less than −1.50 volts (V), a positive section comprising a first metal electrode in contact with the electroactive bipolar redox molecule and a supporting electrolyte dissolved in a solvent, and a negative section comprising a second metal electrode in contact with the electroactive bipolar redox molecule and additional electrolyte dissolved in additional solvent.

Further disclosed herein is an example composition comprising a symmetric electroactive redox molecule with at least 2 reversible reactions separated by at least 3.0 V, wherein the anolyte moiety comprises a multi-ring conjugated system comprising at least one sulfone group, and a supporting electrolyte dissolved in a solvent.

Disclosed herein is also an example method for reversibly storing electrical energy in a symmetric redox flow battery with a unit cell potential equal to or greater than 3.0 V. The method includes flowing a catholyte into contact with a first electrode in a positive section of the redox flow battery, wherein the catholyte comprises at least one sulfone group in a sulfur-containing heterocyclic compound, an electroactive redox molecule comprising an anolyte moiety, wherein the anolyte moiety comprises a sulfone group in sulfur-containing heterocyclic compound, and wherein the anolyte and the catholyte moiety are present in the same cyclic system, flowing an anolyte into contact with a second metal electrode in a negative section of the redox flow battery, wherein the negative section is separated from the positive section with an ion-transporting membrane, wherein the anolyte comprises an additional portion of an organic molecule dissolved in additional solvent, and supplying electrical energy to the first metal electrode and the second metal electrode while an external load is not in electrical communication with the first metal electrode and the second metal electrode to charge the redox flow battery while flowing the catholyte and flowing the anolyte.

Disclosed herein is also an example of a synthesis of a redox active sulfone from a sulfur-containing heterocycle. The synthesis includes reacting the sulfur-containing heterocycle with an acid and an oxidizing agent to form products comprising an oxidized sulfone, wherein the oxidizing agent comprises at least one oxidizing agent selected from the group consisting of aqueous hydrogen peroxide, oxygen, ozone, oxones, potassium chlorate, potassium perchlorate, peroxydisulfuring acid, peroxymonosulfuric acid, hypochlorite, chlorite, chlorate, perchlorate and other halogen analogs, perborates, permanganate, chromate, dichromate or nitric acid, cerium (IV) containing compounds, chromium (VI) containing compounds, vanadium (V) containing compounds, an iron (VI) containing compound, and any combinations thereof. Further, the synthesis comprises separating the products from unreacted portions of the acid and the oxidizing agent, wherein the products comprising the oxidized sulfone is a redox-active molecule with at least one electrochemically reversible reaction at a cell potential less than −1.5 V.

These and other features and attributes of the disclosed methods and systems of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings.

FIG. 1 is a cyclic voltammogram of 5 mM diphenyl sulfone+0.1 M N-tetrabutylammonium hexafluorophosphate (TBAPF₆) in acetonitrile (100 mV/s) between −2.7 V to +0 V.

FIG. 2 is a cyclic voltammogram of 5 mM dibenzothiophene sulfone+0.1 M N-tetrabutylammonium hexafluorophosphate (TBAPF₆) in acetonitrile (100 mV/s) between −2.5 V to +0 V.

FIG. 3 is a cyclic voltammogram of 5 mM 2-methoxythianthrene-5,5,10,10-tetraoxide+0.1 M N-tetrabutylammonium hexafluorophosphate (TBAPF₆) in acetonitrile (100 mV/s) between 2.0 V to +0 V.

FIG. 4 is a cyclic voltammogram of 5 mM 1-methoxythianthrene-5,5,10,10-tetraoxide+0.1 M N-tetrabutylammonium hexafluorophosphate (TBAPF₆) in acetonitrile (100 mV/s) between-2.1 V to +0 V.

FIG. 5 is a cyclic voltammogram of 5 mM 3,7-di-tert-butyl-10-hexyl-10H-phenothiazine 5,5-dioxide+0.1M TBAPF₆ in acetonitrile at 100 mV/s between −3.0 V to +1.25 V.

FIG. 6 is a cyclic voltammogram of 5 mM dibenzothiophene sulfone+0.1M TBAPF₆ in acetonitrile at 100 mV/s between −2.5 V to 0 V.

FIG. 7 is a cyclic voltammogram of 5 mM 4,6-diethyl-dibenzo[b,d]thiophene 5,5-dioxide+0.1M TBAPF₆ in acetonitrile at 100 mV/s between −2.5 V to +0 V.

FIG. 8 is a schematic of a membrane characterization setup to assess redox permeability and membrane ionic conductivity of one or more embodiments.

FIG. 9 is a schematic representation of a redox flow battery stack, which may include a plurality of unit electrochemical cells.

FIG. 10A is a depiction of the first approximately 2 hours of cycling a non-aqueous redox flow battery containing 10 mM 3,7-(di-3,7-di-tert-butyl-10-pentyl-10H-phenothiazine 5,5-dioxide as a symmetric redox active material according to embodiments of the present disclosure.

FIG. 10B depicts the coulombic efficiency (solid) and discharge capacity (dashed) achieved during the first 100 cycles of a battery according to embodiments of the present disclosure.

### DETAILED DESCRIPTION

This disclosure relates to electrochemical energy storage comprising high-voltage bipolar redox organic molecules and redox flow battery systems utilizing these molecules for energy storage. More specifically, example embodiments relate to systems, compositions, and methods for reversibly storing electrical energy in a redox flow battery with a unit cell potential equal to or greater than 3.0 V.

The redox potential of most flow battery chemistries utilizing an aqueous solvent is realistically limited by the competing challenges with water electrolysis. Water electrolysis is thermodynamically feasible at room temperature at cell potentials higher than 1.22 V. However, it can be challenging to develop an aqueous redox flow battery with a cell potential higher than 3.0 V. The use of non-aqueous solvents can support the stable operation of much higher cell potentials, but crossover-tolerant symmetric molecules with voltages higher than 3.0 V are typically unavailable.

Sulfur-containing compounds are a prominent component of sour crude oil, with greater than 10 weight percent present in some sour crude samples. In the absence of alternate disposition for these compounds, hydrodesulfurization is often employed to reduce the sulfur fraction in crude oil. The utilization of sulfur fractions in energy storage applications represents an opportunity to reduce the hydrotreating load of a refinery while offering a valorized product for energy storage. The use of sulfur heterocycles in redox flow batteries is limited to catholytes comprising phenothiazine derivatives, tethered molecules of thianthrene-quinones, and thianthrene-quinoxaline. There has been no oxidized sulfur containing heterocycle used in literature.

Example embodiments disclosed herein include systems and methods to desulfurize sour crude oil and any sour feed or by-products in a refinery by oxidizing sulfur-containing heterocycles into redox-active molecules for redox-flow batteries. The oxidation of sulfur-containing heterocycles to sulfones forms an electron-deficient sulfone moiety as the sulfone group (—SO₂) is strongly withdrawing. This electron-deficient sulfone moiety may be used as redox anolytes or as anolyte moiety in an electroactive bipolar redox molecule for redox flow batteries in accordance with example embodiments. Also, disclosed herein are example systems for energy storage including a positive section, a negative section, and an electroactive bipolar redox molecule comprising an anolyte moiety and a catholyte moiety separated by a non-conjugating insulating linker. The anolyte moiety comprises conjugated system containing at least one sulfone group such as benzyl sulfone, diphenyl sulfone, sulfone, phenothiazine sulfone, dibenzothiophene sulfone, and disulfones of thianthrene. The conjugated system may be linear or cyclic and may include one or more aromatic rings.

Disclosed herein is also a method for reversibly storing electrical energy in a redox flow battery using a symmetric oxidized heterocyclic sulfone redox molecule with a unit cell potential equal to or greater than 3.50 V, or an asymmetric oxidized sulfur heterocyclic redox molecule with a half-cell potential less than −1.50 V. The method includes flowing a catholyte into contact with a first electrode in a positive section of the redox flow battery; flowing an anolyte containing at least an oxidized sulfur containing heterocycle (heterocyclic sulfone) into contact with a second electrode in a negative section of the redox flow battery, wherein the negative section is separated from the positive section with an ion-transporting membrane, wherein the anolyte comprises an additional portion of the organic molecule dissolved in additional solvent; and supplying electrical energy to the first metal electrode and the second metal electrode while an external load is not in electrical communication with the first metal electrode and the second metal electrode to charge the redox flow battery while flowing the catholyte and flowing the anolyte.

Example embodiments may include desulfurization of sour crude oil and any sour feed or by-products in a refinery by oxidizing sulfur-containing heterocycles into redox-active molecules for redox-flow batteries. The oxidation of sulfur-containing heterocycles to sulfones forms an electron-deficient sulfone moiety as the sulfone group (—SO₂) is strongly withdrawing. This electron-deficient sulfone moiety may be used as redox anolytes or as anolyte moiety in an electroactive bipolar redox molecule for redox flow batteries. The redox flow batteries may be considered symmetric as the electroactive bipolar redox molecule can be used as the anolyte and the catholyte. Example embodiments of the electroactive bipolar redox molecule combine anolyte and catholyte moieties separated by a non-conjugating insulating linker. In some embodiments, desirable electrochemical cell potentials are achieved by combining a multi-ring conjugated system containing at least one sulfone group such as benzyl sulfone, diphenyl sulfone, phenothiazine sulfone, dibenzothiophene sulfone, and disulfones of thianthrene as anolyte moiety.

Symmetric redox-active species utilizing multiple redox states of a transition metal have been reported in the literature. The vanadium redox flow battery is the most well-known of these systems and utilizes a [VO]⁺²|[VO₂]⁺ redox couple as the anolyte, and a V⁺²|V⁺³ couple as the catholyte. While this chemistry is capable of achieving very long cycle life (e.g., >10,000 cycles), the thermodynamic cell potential and resulting energy density is quite low.

TABLE 1
Reactions in a Symmetric Vanadium Redox Flow Battery.

| | Redox potential |
|---|---|
| Electrochemical reaction | (V vs SHE) |
| V²⁺ [symbol] V³⁺ + e⁻ | −0.26 |
| [VO]²⁺2H⁺ + e⁻ [symbol] [VO₂]⁺ + H₂O | +1.00 |

In contrast, the example systems of the present disclosure, which include symmetric redox flow batteries based on organic molecules, comprising an electroactive bipolar redox molecule combining a multi-ring conjugated systems containing at least one sulfone group as anolyte moiety and a catholyte moiety separated by a non-conjugating insulating linker, achieve much higher voltages than the aqueous alternative by suppressing solvent decomposition.

For example, aqueous systems are limited by water electrolysis, which is initiated at potentials above 1.22 V. Symmetric operation is achieved by using the same electroactive bipolar redox molecule comprising anolyte and catholyte moieties separated by a non-conjugating insulating linker on each side of the membrane. In this symmetric system, the redox flow battery has identical components in each half-cell, which alleviates the problems associated with chemical gradients when different redox active organic molecules are on each side of the membrane resulting in membrane crossover, permanent contamination, and flow battery capacity decay.

In one or more embodiments, the electroactive bipolar redox molecule comprises an anolyte moiety. Examples of suitable anolyte moieties include multi-ring conjugated systems containing at least one sulfone group such as benzyl sulfone, diphenyl sulfone, phenothiazine sulfone, dibenzothiophene sulfone, and disulfones of thianthrene, their derivatives, and isomers. For example, derivatives of disulfones of thianthrene include any compound that is derived from disulfones of thianthrene by a chemical reaction. The replacement of one of the hydrogen atoms of thianthrene by another atom or group of atoms form a derivative of thianthrene, for example. Examples of one to 4 suitable substituents include alkoxy groups, alkyl groups with 1-10 carbon atoms, glycolic, halogen groups (chloro-, bromo-, fluoro or iodo-). The selection of these moieties is expected to include stereoisomers, for example, cis- and trans-isomers.

In one or more embodiments, the electroactive bipolar redox molecule combines thianthrene-5,5,10,10-tetraoxide thianthrene with a methoxy group to give 1-methoxythianthrene-5,5,10,10-tetraoxide and 2-methoxythianthrene-5,5,10,10-tetraoxide.

In one or more embodiments, the electroactive bipolar redox molecule combines phenothiazine 5,5-dioxide with hexyl and tertbutyl group to give 3,7-di-tert-butyl-10-hexyl-10H-phenothiazine 5,5-dioxide.

In one or more embodiments, the electroactive bipolar redox molecule is dibenzothiophene sulfone.

In one or more embodiments, the electroactive bipolar redox molecule is 4,6-diethyl-dibenzo[b,d]thiophene 5,5-dioxide.

Cyclic voltammetry is a powerful and popular electro-chemical technique commonly employed to investigate the reduction and oxidation processes of molecular species. A cyclic voltammogram is acquired for each redox-active species, the oxidative peak and reductive peak recorded, and the halfway potential between the two observed peaks, E_{1/2}, calculated. All reported E_{1/2} values are measured against a silver/silver nitrate reference electrode (Ag|10 mM AgNO₃ in acetonitrile), whose potential is −0.09 V versus a ferrocene|ferrocenium redox couple (Fc|Fc⁺).

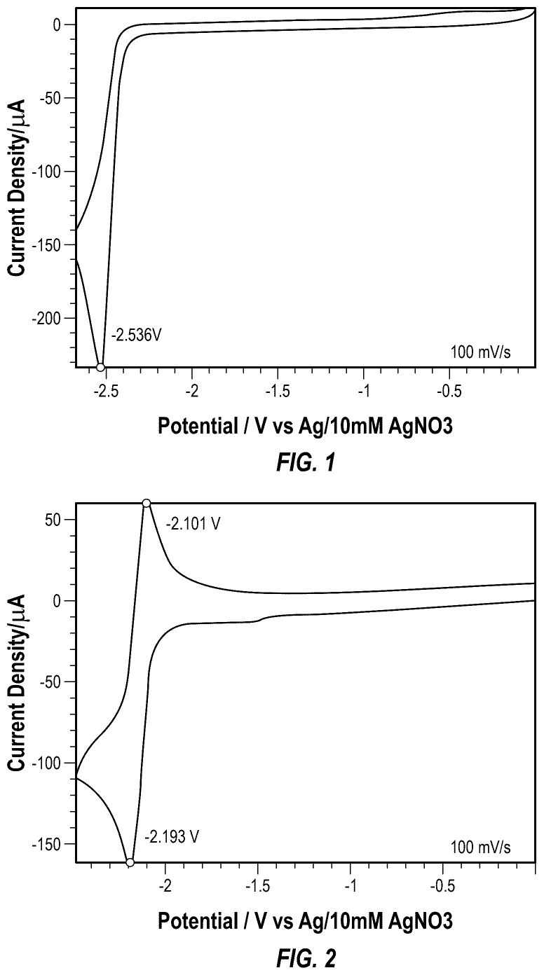

For instance, diphenyl sulfone is chemically unstable as the electron density is not sufficiently delocalized resulting in poor cyclic voltammetry as illustrated in FIG. 1 with the cyclic voltammogram of 5 mM diphenyl sulfone+0.1 M N-tetrabutylammonium hexafluorophosphate (TBAPF₆) in acetonitrile (100 mV/s) between −2.7 V to +0 V. However, as an heterocycle is formed around the sulfur atom resulting in the formation of dibenzothiophene sulfone, the charge can be delocalized over a multi-ring conjugated system leading to a stable charged radical and a highly reversible anolytic reaction with redox potential, E_{1/2}, at −2.147 V as illustrated by the reversibility of the cyclic voltammetry of 5 mM dibenzothiophene sulfone+0.1 M N-tetrabutylammonium hexafluorophosphate (TBAPF₆) in acetonitrile (100 mV/s) between −2.5 V to +0 V.

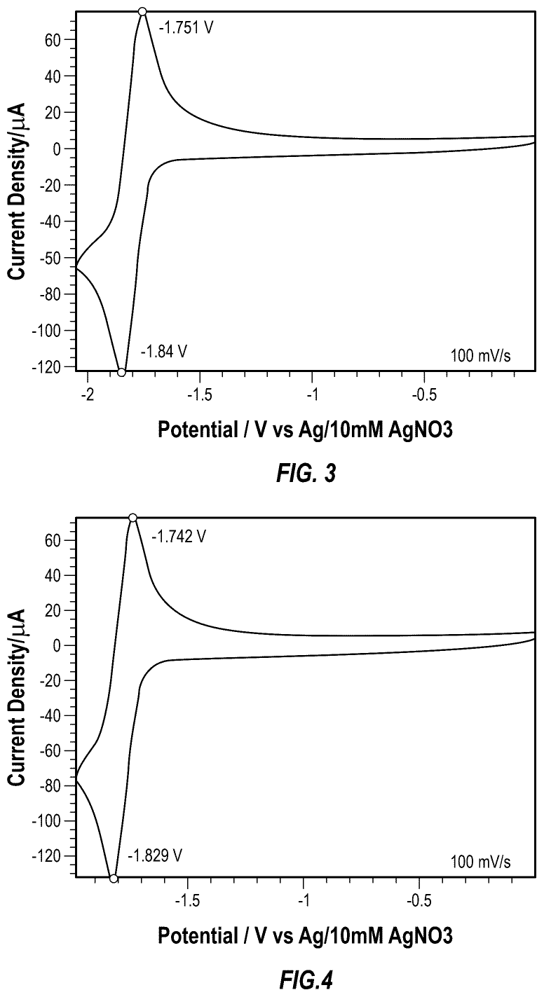

Further, the attachment of an electron-donating methoxy-substituent to thianthrene-5,5,10,10-tetraoxide results in the formation of 2-methoxythianthrene-5,5,10,10-tetraoxide with a highly reversible anolytic reaction with redox potential, E_{1/2}, at −1.796 V as illustrated in FIG. 3 with the cyclic voltammogram of 5 mM 2-methoxythianthrene-5,5,10,10-tetraoxide+0.1 M N-tetrabutylammonium hexafluorophosphate (TBAPF₆) in acetonitrile (100 mV/s) between +2.0 V to +0 V. The attachment of an electron-donating methoxy-substituent to thianthrene-5,5,10,10-tetraoxide results in the formation of 1-methoxythianthrene-5,5,10,10-tetraoxide as well with a highly reversible anolytic reaction with redox potential, E_{1/2}, at −1.786 V as well as illustrated in FIG. 4 with the cyclic voltammogram of 5 mM 2-methoxythianthrene-5,5,10,10-tetraoxide+0.1 M N-tetrabutylammonium hexafluorophosphate (TBAPF₆) in acetonitrile (100 mV/s) between +2.1 V to +0 V.

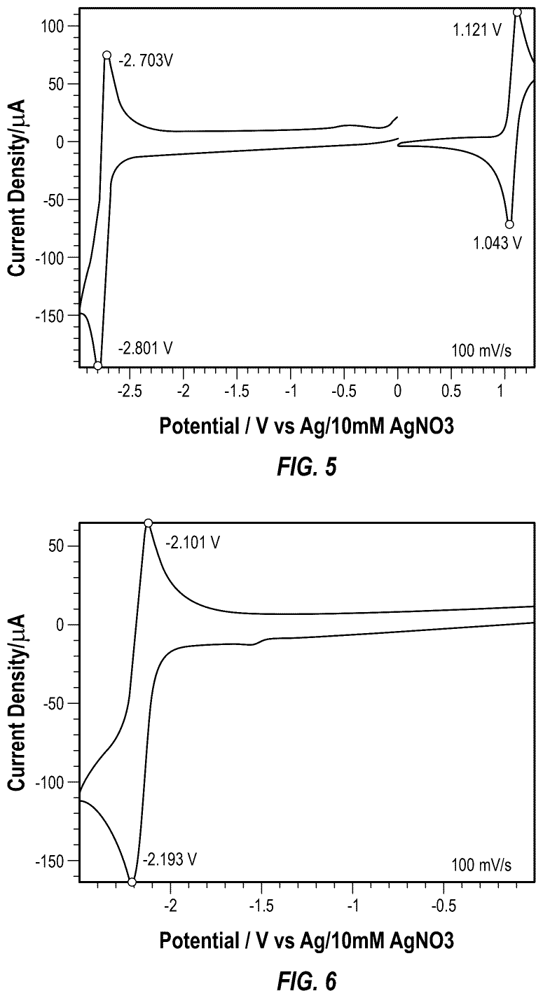

The attachment of tertbutyl and hexyl groups to phenothiazine-5,5-dioxide results in the formation of 3,7-di-tert-butyl-10-hexyl-10H-phenothiazine 5,5-dioxide with a highly reversible catholytic reaction with a redox potential, E_{1/2}, at −2.752 V and +1.082 V as illustrated in FIG. 5 with the cyclic voltammogram of 5 mM 3,7-di-tert-butyl-10-hexyl-10H-phenothiazine 5,5-dioxide+0.1M TBAPF₆ in acetonitrile at 100 mV/s between −3.0 V to +1.25 V.

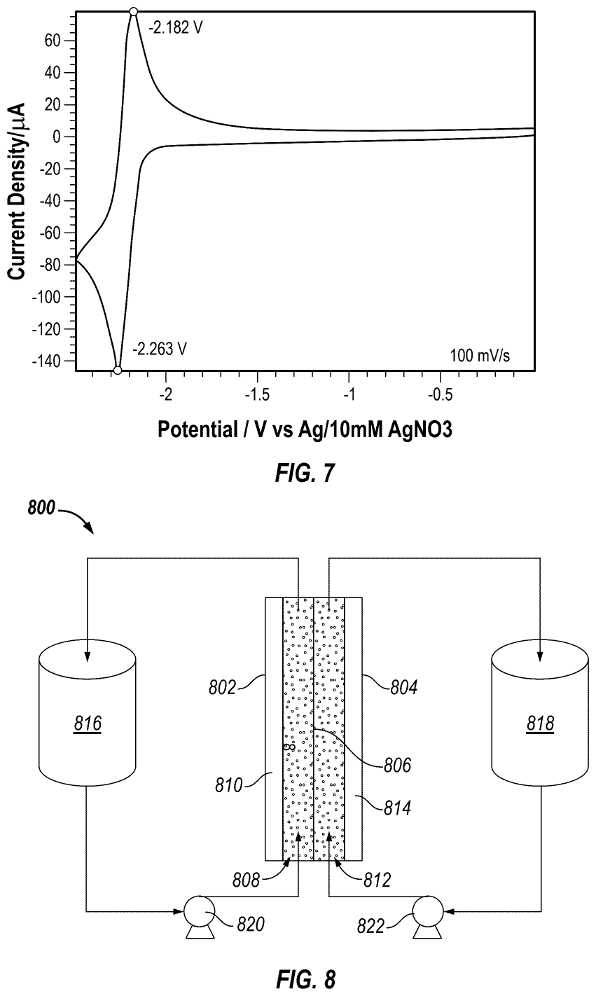

FIG. 6 illustrates a cyclic voltammogram of 5 mM dibenzothiophene sulfonc+0.1M TBAPF₆ in acetonitrile at 100 mV/s between −2.5 V to 0 V with a highly reversible anolytic reaction with redox potential, E_{1/2}, at −2.147 V. Finally, the attachment of two ethyl groups to dibenzothiophene sulfone results in the formation of 4,6-diethyl-dibenzo[b,d]thiophene 5,5-dioxide with a highly reversible catholytic reaction with a redox potential, E_{1/2}, at −2.223 V as illustrated in FIG. 7 with the cyclic voltammogram of 5 mM 4,6-diethyl-dibenzo[b,d]thiophene 5,5-dioxide+0.1M TBAPF₆ in acetonitrile at 100 mV/s between −2.5 V to +0 V.

### Redox Flow Batteries

Redox flow batteries are electrochemical devices that store energy in the different oxidation states of the selected elements. Often, these elements are soluble and exist as ions dissolved in an acidic solvent. The principle of operation for redox flow batteries is similar to that of conventional batteries, where oxidation and reduction reactions at two electrodes enables electrons to flow. The difference with a redox flow battery is the manner in which the reactants are stored. Redox flow batteries typically include two electrodes, a separator, and an electrolyte. However, the reactants are stored as dissolved ions in a solution, rather than physically incorporated into the electrode. As such, the reactant solutions for redox flow batteries can be stored in tanks, and then the solutions can be pumped through a cell where the reactions will occur to generate electricity.

In one or more embodiments, the redox flow battery of the present disclosure includes an electroactive bipolar redox molecule. The electroactive bipolar redox molecule combines anolyte and catholyte moieties separated by a non-conjugating insulating linker. Examples of suitable anolyte moieties include multi-ring conjugated systems containing at least one sulfone group such as phenothiazine sulfone, dibenzothiophene sulfone, and disulfones of thianthrene, their derivatives, and isomers. The multi-ring conjugated systems containing at least one sulfone group has a highly reversible anolytic reaction with redox potential equal or lower than −1.5 V, E_{1/2}≤−1.5 V, versus Ag/AgNO₃. In symmetric systems utilizing sulfone groups, the high electrochemical cell potentials above 3.0 V are achieved combining the suitable anolyte with a suitable catholyte moiety while sharing the same conjugated system. This unique attribute differentiates the oxidized sulfur molecules from other bipolar molecules reported in literature that utilize anolyte and catholyte moieties linked through an insulating alkyl chain.

Disclosed herein is also an example method for reversibly storing electrical energy in a symmetric nonaqueous redox flow battery with a unit cell potential greater than 3.0 V or an asymmetric redox flow battery utilizing an oxidized sulfone anolyte with a half-cell potential less than −1.50 V (vs Ag|0.01 M AgNO₃ in acetonitrile) as compared to the reference electrode. In some embodiments, the method may include flowing the electroactive bipolar redox molecule into contact with a first metal electrode in a positive section of the redox flow battery as catholyte, wherein the electroactive bipolar redox molecule combines the suitable anolyte and catholyte moieties separated by a non-conjugating insulating linker. The method may further include flowing the single electroactive bipolar redox molecule into contact with a second metal electrode in a negative section of the redox flow battery as anolyte, wherein the negative section is separated from the positive section with an ion-transporting membrane, wherein the anolyte is dissolved in additional solvent; and supplying electrical energy to the first metal electrode and the second metal electrode while an external load is not in electrical communication with the first metal electrode and the second metal electrode to charge the redox flow battery while flowing the catholyte and flowing the anolyte. The solvent may be the same in the positive section and in the negative section of the redox flow battery or it may be different. The redox flow battery can further include a single tank or two separate tanks, one to supply the positive section, also called the catholyte tank, and the other tank, the anolyte tank, to supply the negative section, each tank holding the electroactive bipolar redox molecule. A catholyte pump can be used to circulate the electroactive bipolar redox molecule from the catholyte tank to the positive portion while an anolyte pump circulates the electroactive bipolar redox molecule from the anolyte tank to the negative portion. The redox flow battery can further include a load for directing electrical energy into or out of the redox flow battery.

Disclosed herein are systems for organic redox flow batteries utilizing metal-free, multi-component, redox-active, and ionically conductive low-transition temperature materials. There may be several potential advantages to the methods and systems disclosed herein, only some of which may be alluded to in the present disclosure. As discussed above, current chemistry used in redox flow batteries may be limited by the solubility of the redox species in the solvent. The low-transition temperature material may have a melting temperature of less than 100° C. The electrochemical potential of the redox-active low-transition temperature material is large enough for use as a negative electrolyte (anolyte) solution and positive electrolyte (catholyte) solution in a redox flow battery. The redox flow battery may be solvent-free, where the two half-cells of the redox flow battery comprise mainly the low-transition temperature material thereby allowing a larger mole fraction of the low-transition temperature material to be present in solution leading to greater energy density. The materials disclosed herein can undergo multi-electron charge transfer reactions and may achieve an energy density of greater than 100 WhL⁻¹. Further, the low-transition temperature material may be synthesized from hydrocarbons thereby eliminating the challenges associated with availability of mined materials.

In example embodiments, the electrolyte solutions comprise the electroactive bipolar redox organic molecule with at least one redox state dissolved in a solvent. For instance, the electrolyte comprising the redox organic molecule in one or more redox states may also comprise one or more solvents and one or more ionically dissociative compounds as supporting electrolyte. The solvent can be any solvent that is non-reactive with the electroactive bipolar redox molecule and permits the redox active organic molecule to efficiently undergo redox reactions such that the energy storage system can be effectively charged and discharged. The solvent may be the same in the positive section and in the negative section of the redox flow battery or it may be different.

The solvent of the present disclosure can be, for example, aqueous-based or non-aqueous (organic), protic or aprotic, and either polar or non-polar. The aqueous-based solvent can be, for example, water, or water in admixture with a water-soluble co-solvent. Some examples of protic organic solvents include alcohols, such as methanol, ethanol, n-propanol, isopropanol, n-butanol, sec-butanol, isobutanol, t-butanol, n-pentanol, isopentanol, 3-pentanol, neopentyl alcohol, n-hexanol, 2-hexanol, 3-hexanol, 3-methyl-1-pentanol, 3,3-dimethyl-1-butanol, isohexanol, and cyclohexanol. The protic organic solvent may alternatively be or include a carboxylic acid, such as acetic acid, propionic acid, butyric acid, or a salt thereof.

Some examples of polar aprotic solvents include nitrile solvents (e.g., acetonitrile, propionitrile, and butyronitrile), sulfoxide solvents (e.g., dimethyl sulfoxide, ethyl methyl sulfoxide, diethyl sulfoxide, methyl propyl sulfoxide, and ethyl propyl sulfoxide), sulfone solvents (e.g., methyl sulfone, ethyl methyl sulfone, methyl phenyl sulfone, methyl isopropyl sulfone, propyl sulfone, butyl sulfone, tetramethylene sulfone, i.e., sulfolane), amide solvents (e.g., N,N-dimethylformamide, N,N-diethylformamide, acetamide, dimethylacetamide, and N-methylpyrrolidone), ether solvents (e.g., diethyl ether, 1,2-dimethoxyethane, 1,2-diethoxyethane, 1,3-dioxolane, and tetrahydrofuran), carbonate solvents (e.g., propylene carbonate, ethylene carbonate, butylene carbonate, chloroethylene carbonate, fluorocarbonate solvents, dimethyl carbonate, diethyl carbonate, dipropyl carbonate, ethyl methyl carbonate, methyl propyl carbonate, and ethyl propyl carbonate), organochloride solvents (e.g., methylene chloride, chloroform, 1,1,-trichloroethane), ketone solvents (e.g., acetone and 2-butanone), and ester solvents (e.g., 1,4-butyrolactone, ethylacetate, methylpropionate, ethylpropionate, and the formates, such as methyl formate and ethyl formate). The polar aprotic solvent may also be or include, for example, hexamethylphosphoramide (HMPA), 1,3-dimethyl-3,4,5,6-tetrahydro-2 (1H)-pyrimidinone (DMPU), or propylene glycol monomethyl ether acetate (PGMEA). Some examples of polar inorganic solvents include supercritical carbon dioxide, carbon disulfide, carbon tetrachloride, ammonia, and sulfuryl chloride fluoride. Some examples of non-polar solvents include the liquid hydrocarbons, such as the pentanes, hexanes, heptanes, octanes, pentenes, hexenes, heptenes, octenes, benzene, toluenes, and xylenes.

In some embodiments, the electrolyte of the present disclosure also comprises ionic salts as supporting electrolytes. A necessary attribute is that these salts dissociate ionically in the solvent and have a solubility of at least 0.1 moles per liter of solution, or 0.1 M and up to 10 M. Examples include salts containing alkali metals (Li, Na, K, Rb, Cs), quaternary ammonium, oxonium, sulfonium cations. Examples also include salts containing BF₄, trifluoromethanesulfonimide, PF₆, nitrate and halogen group anions. In yet other embodiments, the solvent and supporting electrolyte may be the same materials. Examples of these include ionic liquids containing imidazolium-, pyrrolidinium-, phosphonium-, trialkyloxonium, trialkylsulfonium cations, either alone or in admixture with a non-ionic liquid solvent.

The electroactive bipolar redox molecule of the present disclosure may be present in the solvent in any suitable amount. For example, from 0.01 M to 5 M, or from 0.01 M to 1 M, or from 0.025 to 0.5 M of the electroactive sulfone-containing redox molecule is present in the system.

The positive and negative electrodes may be any suitable electrode. For example, the positive and negative electrodes may be independently selected from, for example, graphite, carbon felt, glassy carbon, nickel on carbon, porous nickel sulfide, nickel foam, platinum, palladium, gold, titanium, titanium oxide, ruthenium oxide, iridium oxide, or a composite, such as a carbon-polyolefin composite, or a composite containing polyvinylidene difluoride (PVDF) and activated carbon, or a composite of platinum and titanium, e.g., platinized titanium. In some embodiments, the electrode material may include or be composed of an element selected from C, Si, Ga, In, Al, Ti, V, Cr, Fc, Co, Ni, Cu, Zr, Nb, Ta, Mo, W, Rc, Ru, Os, Rh, Ir, Pd, Pt, Ag, Au, alloys thereof, degenerately-doped semiconductors thereof, and oxides thereof. The choice of electrode material may be dependent on the choice of redox active molecule, solvent, and other aspects of the redox flow battery in particular embodiments. For this reason, any of the specific classes or types of electrode materials described above may be excluded or specifically selected in particular embodiments.

In accordance with example embodiments, the separator separates the catholyte in the positive compartment or positive section from the anolyte in the negative compartment or negative section to prevent the organic redox molecules in the positive and negative sections from intermingling with each other. However, the separator should possess a feature that permits the passage of non-redox-active species between the catholyte and anolyte. The non-redox-active species are those ionic species, well known in the art, that establish electrical neutrality and complete the circuitry in a battery, and which are included as either a supporting electrolyte or are formed during the course of the redox reactions in each compartment. In order to permit flow of non-redox-active species, the separator may be, to some extent, porous. Some examples of inorganic or ceramic compositions for the separator component include alumina, silica (e.g., glass), titania, and zirconia. Porous organic polymers that do not separate by ionic charge but rather, size exclusion, may also be used. These can work like physical barriers directing flow geometry to prevent mixing. The separator component may operate selectively or non-selectively in its ion permeability. The separator component can have any suitable thickness and hardness. In some embodiments, the separator component is in the form of a membrane.

In a particular embodiment, the separator is an ion-selective membrane. The ion-selective membrane, also known as an ion exchange membrane (IEM), can be any organic, inorganic (e.g., ceramic), hybrid, or composite membranes known in the art, such as those used in redox flow batteries of the art and suitable for the purposes of the invention described herein. The ion-selective membrane should substantially or completely block passage of the redox active molecule between positive and negative compartments while permitting the flow of solvent molecules and/or ion species that may evolve or be present during the electron transport process, such as hydrogen ions, halide ions, or metal ions. In some embodiments, the ion-selective membrane is a cation-selective membrane, while in other embodiments, the ion-selective membrane is an anion-selective membrane. The ion-selective membrane can include or be composed of, for example, poly(ether ether ketone) (PEEK) or sulfonated version thereof (SPEEK), poly(phthalazinone ether sulfone) (PPES) or sulfonated version thereof (SPPES), poly(phthalazinone ether sulfone ketone) (PPESK) or sulfonated version thereof (SPPESK), or an ionomer, which may be a proton conductor or proton exchange membrane, particularly a fluoropolymer (e.g., a fluorocthylene or fluoropropylene), such as a sulfonated tetrafluoroethylene-based fluoropolymer, such as Nafion®. In some embodiments, the ion-selective membrane has a hybrid structure having an organic component, such as any of the exemplary organic compositions above, in combination with an inorganic material, such as silicon (SiO₂). The hybrid structure can be produced by, for example, a sol gel process. The ion-selective membrane may alternatively be a composite, which includes separate layers of different membrane materials in contact with each other. The choice of membrane material may be dependent on the choice of redox active molecule, solvent, and other aspects of the redox flow battery in particular embodiments. For this reason, any of the specific classes or types of separator materials described above may be excluded or specifically selected in particular embodiments.

In some embodiments, the positive and negative sections may include a plurality of cells in electrical series defined by a stacked repetitive arrangement of a conductive intercell separator having generally a bipolar function, a first metal electrode, an ion exchange membrane, a second metal electrode and another conductive intercell separator. In one or more embodiments, the electrochemical stack comprises a plurality of electrochemical cells, each comprising a current collector for passage of electrical current and flow fields. In one or more embodiments, the stacked repetitive arrangement forming a battery stack comprises from 2 to 200 electrochemical cells.

Supplementary components may include an optional heat exchanger to dissipate heat due to resistive heating, an optional purge gas such as nitrogen or noble gases (xenon, argon, helium, neon, krypton) to exclude air and water vapor, a recirculation device such as a pump, tubing, and manifolds used to direct the transport of the fluid electrolyte between one or more storage tank.

As a redox flow battery operates by flowing the electrolyte solutions over the respective electrodes, the redox flow battery includes circulation devices or pumps or other suitable devices for establishing flow of the electrolyte solutions. In addition to pumps, suitable devices may include a propeller designed for use within a liquid to establish fluid flow. Typically, the redox flow battery includes at least two flow devices, one designated for establishing flow in the positive section, and the other designated for establishing flow in the negative section.

In one embodiment, the electrolyte solutions contained in the positive and negative sections constitute the entire amount of electrolyte solution in the redox flow battery, i.e., no further reserve of electrolyte solution is hydraulically connected with the positive and negative sections. In another embodiment, the positive and negative sections are each connected by one or more conduits (e.g., a pipe or a channel) to storage (reservoir) tanks containing additional electrolyte solution. The additional electrolyte can be stored in one tank connected to the positive and negative section as the electroactive bipolar redox molecule of the disclosure can act as catholyte and as anolyte. Alternatively, at least two tanks can be used to replenish the positive and negative sections. The storage tanks can advantageously serve to replenish spent electrolyte solution and increase the electrical capacity of the redox flow battery. The storage tanks can also advantageously serve to promote flow of the electrolyte solutions, particularly in an arrangement where the positive and negative sections are each connected to at least two storage tanks, in which case the redox flow battery would have at least four storage tanks.

In another embodiment, the invention is directed to a method for storing and releasing electrical energy by use of the above-described redox flow battery. In the example method, the redox flow battery may be first charged by supplying electrical energy to the first metal electrode and the second metal electrode while the external load is not in electrical communication with the first metal electrode and the second metal electrode and while flowing the catholyte and anolyte, during which the organic molecule in the positive section is oxidized and the organic in the negative section is reduced. As such, the electrical energy has been converted and stored as electrochemical energy. The electrochemical energy may be stored in the energetically uphill half reactions occurring in the positive and negative sections during the charging process. The resulting electrochemical potential energy may be stored until a discharging process occurs, during which the stored electrochemical energy is converted to electrical energy while flowing the catholyte and anolyte, with concomitant reversal of the two half reactions (i.e., reduction in the positive section and oxidation in the negative section) to form the initial lower energy redox molecules present in both compartments before the charging process. Each half reaction generally operates by one or more one-electron processes, but they may also operate by multi-electron processes (e.g., one or more, two-, three-, or four-electron processes), depending on the redox active molecule. The source of electrical energy in the charging process can be any desired source of electrical energy. In particular embodiments, the source of electrical energy is a renewable source of energy, such as wind, solar, or hydropower, for example.

FIG. 8 is an example schematic of a redox flow battery system 800 for energy storage. In the illustrated embodiment, the redox flow battery system 800 includes a positive section 802 and a negative section 804. As illustrated, a separator 806 (e.g., a porous separator or an ion selective membrane) may separate the positive section 802 from the negative section 804. As illustrated, the positive section 802 may include a catholyte 808 (positive electrolyte solution) in contact with a first metal electrode 810, (the cathode or positive electrode). As further illustrated, the negative section 804 includes an anolyte 812 (negative electrolyte solution) in contact with a second metal electrode 814 (the anode or negative electrode). In this example, the energy is stored as dissolved ions within the solution, and the amount of energy for the system depends only on the amount of solution available in the catholyte tank 16 and the anolyte tank 818. Larger tanks will be able to store larger amounts of solution, leading to a longer duration discharge. Meanwhile, the power rating of the redox flow battery system 800 is dictated by the cell-level design, such as flow path, the first metal electrode 810, and the second metal electrode 814. The flow rate is controlled by catholyte pump 820 for the catholyte 808 and anolyte pump 822 for the anolyte 812. While “positive” and “negative” are used to describe sections of the redox flow battery system 800, these references do not require that the redox flow battery system 800 be in operation and possess positive or negative polarity, but rather indicates suitability for operation to oxidize/reduce.

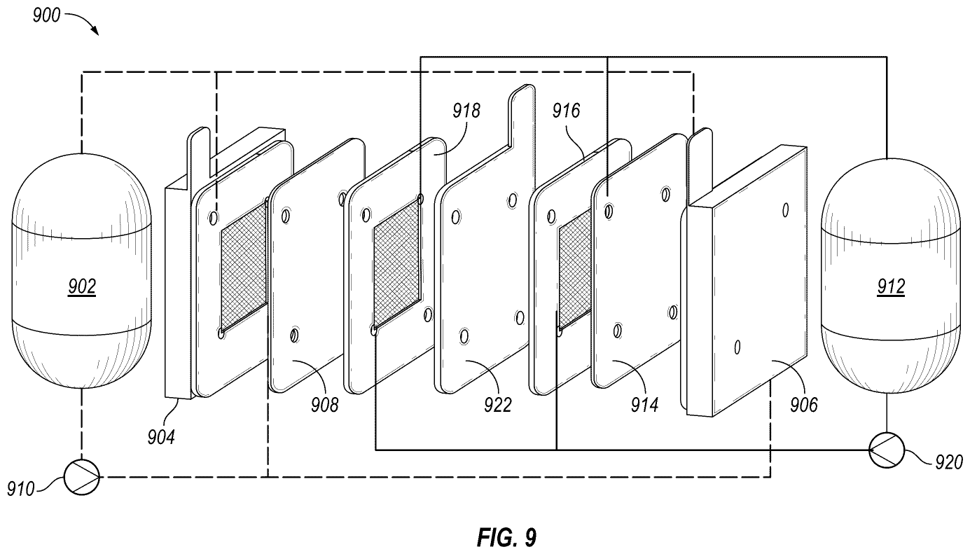

FIG. 9 is a schematic representation of a redox flow battery stack 900, which may include one or more electrochemical unit cells. Each electrochemical unit cell comprises at least an electrically conductive layer, an ionically conductive layer, and mechanisms to direct fluid flow. The number of electrochemical unit cells in a stack may vary from 1 to 250, including both values. The anolyte tank 902 is connected to flowfield/current collectors 904 and 906, and may be comprised of an electrically conductive material, such as metal or conductive carbons such as graphite, graphene, and glassy carbon as well as composite materials including carbon-polymer conductive plastics and electrically conductive glasses. The redox flow battery stack 900 includes a first membrane 908 that enables ion transport through the use of an ion-exchange polymer membrane, ceramic electrolyte, or a porous separator material. The electrolyte is circulated through a first recirculator 910, which may involve a pump or other mechanisms of generating convective fluid flow. Recirculator 910 generates flow of anolytes from anolyte tank 902 to flowfield/current collectors 904 and 906 and back to anolyte tank 902. The catholyte tank 912 is connected to a second membrane 914 and first and second gasket/spacers 916, 918 with embedded electrodes within 916 and 918 through a second recirculator 920, which may be comprised of similar materials as recirculator 910. Membranes 908 and 914 allow charge carriers to move from the anolyte to the catholyte and vice versa depending upon the state of charge or discharge of the battery but restrict mixing between anolyte and catholyte. Both the anolyte tank 902 and catholyte tank 912 may be provided with mechanisms to introduce a purge gas to eliminate contaminants streams in the gaseous phase and mechanisms to condense solvent vapor.

Bipolar plate 922 separates first gasket spacer 916 from second gasket/spacer 918 and utilizes an electrically conductive material. In the schematic representation of redox flow battery stack 900, the anolyte is recirculated by recirculator 910 from anolyte tank 902 to flowfield/current collectors 904 and 906 which are located on the outside of the gasket/spacers 916, 918 wherein the catholyte is recirculated from catholyte tank 912 by recirculator 920 with membranes 908 and 914 in between.

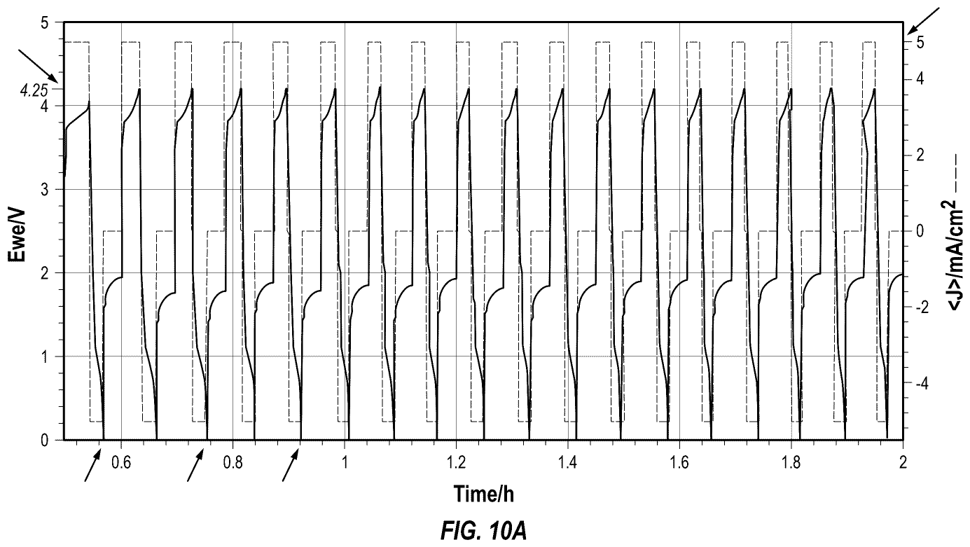

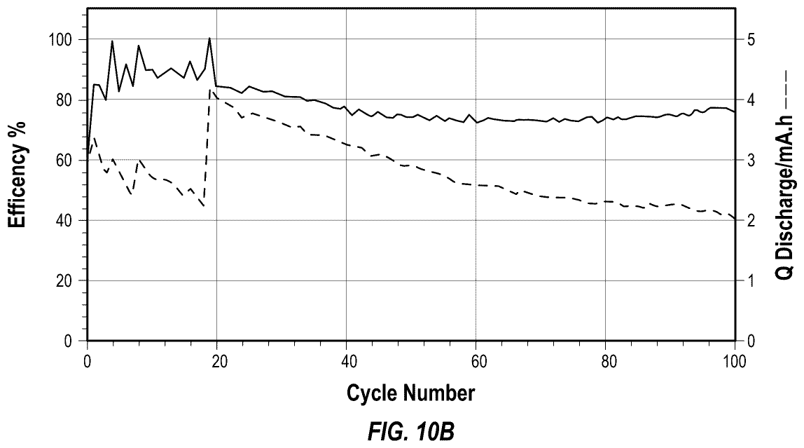

FIG. 10A is a depiction of the first approximately 2 hours of cycling a non-aqueous redox flow battery containing 10 mM 3,7-(di-3,7-di-tert-butyl-10-pentyl-10H-phenothiazine 5,5-dioxide as a symmetric redox active material. The thermodynamic cell potential of this redox material is approximately 3.83 volts, and has two reversible electrochemical reactions at −2.752 volts and +1.082 volts respectively (versus an Ag|10 mM AgNO₃ reference electrode). The supporting electrolyte used is 0.5 M tetraethylammonium hexafluorophosphate in acetonitrile solvent. The electrochemical cell used a Daramic-850 film as a porous separator. The fluid phase was recirculated at 30 mL/min and was cycled between voltage limits of 4.25 V and 0 V at a current density of 5 mA/cm².

FIG. 10B depicts the coulombic efficiency (solid) and discharge capacity (dashed) achieved during the first 100 cycles of the same battery, indicating stable and reversible operation.

In practice, the flow battery current density and energy density can be reasonably expected to scale linearly with concentration, and current density of at least 100 mA per cm² and theoretic energy density of 51.8 Wh/L is expected at a redox concentration of 1 mol/L of the redox species.

Accordingly, the present disclosure may provide redox electrochemical systems comprising high-voltage multivalent organic molecules comprising the single electroactive bipolar redox molecule of the present disclosure and methods of identifying these systems. The methods and systems may include any of the various features disclosed herein, including one or more of the following embodiments.

Embodiment 1. A system for energy storage comprising: an electroactive redox molecule comprising an anolyte moiety comprising a multi-ring conjugated system comprising at least one sulfone group, wherein an anolyte reaction occurs at a cell potential less than −1.50 V; a positive section comprising a first metal electrode in contact with the electroactive bipolar redox molecule and a supporting electrolyte dissolved in a solvent; and a negative section comprising a second metal electrode in contact with the electroactive bipolar redox molecule and additional electrolyte dissolved in additional solvent.

Embodiment 2. The system of Embodiment 1, wherein the anolyte moiety comprises at least one anolyte moiety selected from the group consisting of phenothiazine sulfone, dibenzothiophene sulfone, disulfones of thianthrene, and any combinations thereof.

Embodiment 3. The system of Embodiment 1 or Embodiment 2, wherein the electroactive redox molecule has at least two reversible redox reactions corresponding to an electrochemical unit cell potential greater than or equal to 3.0 V.

Embodiment 4. The system of any preceding Embodiments, wherein the electroactive moiety with the at least two reversible reactions comprise at least one electroactive moiety selected from the group consisting of phenothiazine-5,5-dioxide, thianthrene S-dioxide, and any combinations thereof and has an electrochemical unit cell potential greater than or equal to 3 V.

Embodiment 5. The system of any preceding Embodiments, wherein the electroactive redox molecule is dispersed as a non-fluid suspension or emulsion in a polar aprotic fluid, wherein the polar aprotic fluid comprises at least one polar aprotic fluid selected from the group consisting of acetonitrile, dimethoxyethane, dimethylsulfoxide, dimethylacetamide, N,N-dimethylformamide, ethylene carbonate, propylene carbonate, nitromethane, propyl sulfone, butyl sulfone, propionitrile, valeronitrile, glutaronitrile, gamma-valerolactone, gamma-butyrolactone and sulfolane, and any combination thereof.

Embodiment 6. The system of any preceding Embodiments, wherein the concentration of the redox molecule is at least 0.5 moles per liter of a dispersed fluid phase.

Embodiment 7. The system of any preceding Embodiments, wherein the positive section is separated from the negative section by a porous separator and/or an ion-selective membrane, and wherein the system further comprises: a circulation device configured to circulate a catholyte or an anolyte from a storage tank to the positive section or the negative section; mechanisms to provide flow of an inert gas purge such as nitrogen or a noble gas, and mechanisms to condense solvent vapor from the purge gas stream and reintroduce them to the recirculating fluid loop comprising the redox electroactive moiety.

Embodiment 8. The system of any preceding Embodiments, further comprising from 2 to 250 electrochemical cells to form a battery stack, wherein each of the electrochemical cells comprises a corresponding positive section comprising a catholyte and a corresponding negative section comprising an anolyte moiety comprising a sulfone group in a sulfur heterocycle compound.

Embodiment 9. The system of any preceding Embodiments, wherein the positive section is separated from the negative section by a porous separator and/or an ion-selective membrane, and wherein the system further comprises a circulation device configured to circulate a catholyte or an anolyte from a storage tank to the positive section or the negative section.

Embodiment 10. A composition comprising: a symmetric electroactive redox molecule with at least 2 reversible reactions separated by at least 3.0 V, wherein the anolyte moiety comprises a multi-ring conjugated system comprising at least one sulfone group; and a supporting electrolyte dissolved in a solvent.

Embodiment 11. The composition of Embodiment 10, wherein the anolyte moiety comprises at least one anolyte moiety selected from the group consisting of phenothiazine sulfone, dibenzothiophene sulfone, disulfones of thianthrene, and any combinations thereof.

Embodiment 12. A method for reversibly storing electrical energy in a symmetric redox flow battery with a unit cell potential equal to or greater than 3.0 V, the method comprising: flowing a catholyte into contact with a first electrode in a positive section of the redox flow battery, wherein the catholyte comprises at least one sulfone group in a heterocyclic sulfur compound, an electroactive redox molecule comprising an anolyte moiety, wherein the anolyte moiety comprises a sulfone group in a sulfur-containing heterocyclic compound, and wherein the anolyte and the catholyte moiety are present in the same cyclic system; flowing an anolyte into contact with a second metal electrode in a negative section of the redox flow battery, wherein the negative section is separated from the positive section with an ion-transporting membrane, wherein the anolyte comprises an additional portion of an organic molecule dissolved in additional solvent; and supplying electrical energy to the first metal electrode and the second metal electrode while an external load is not in electrical communication with the first metal electrode and the second metal electrode to charge the redox flow battery while flowing the catholyte and flowing the anolyte.

Embodiment 13. The method of Embodiment 12, wherein the anolyte moiety comprises at least one anolyte moiety selected from the group consisting of phenothiazine sulfone, dibenzothiophene sulfone, disulfones of thianthrene, and any combination thereof.

Embodiment 14. The method of Embodiment 12 or Embodiment 13, further comprising discharging the redox flow battery by establishing electrical communication between the external load with the first metal electrode and the second metal electrode while flowing the catholyte and flowing the anolyte.

Embodiment 15. A method of synthesizing a redox active sulfone from a sulfur-containing heterocycle comprising: reacting the sulfur-containing heterocycle with an acid and an oxidizing agent to form products comprising an oxidized sulfone, wherein the oxidizing agent comprises at least one oxidizing agent selected from the group consisting of aqueous hydrogen peroxide, oxygen, ozone, oxones, potassium chlorate, potassium perchlorate, peroxydisulfuring acid, peroxymonosulfuric acid, hypochlorite, chlorite, chlorate, perchlorate and other halogen analogs, perborates, permanganate, chromate, dichromate or nitric acid, cerium (IV) containing compounds, chromium (VI) containing compounds, vanadium (V) containing compounds, an iron (VI) containing compound, and any combinations thereof; separating the products from unreacted portions of the acid and the oxidizing agent, wherein the products comprising the oxidized sulfone is a redox-active molecule with at least one electrochemically reversible reaction at a cell potential less than −1.5 V.

Embodiment 16. The method of Embodiment 15, wherein the sulfur-containing heterocycle comprises a phenothiazine moiety and the products have two reversible electrochemical reactions separated by a cell potential greater than or equal to 3.0 V.

Embodiment 17. The method of Embodiment 15 or Embodiment 16, wherein the redox active sulfone has at least one electrochemically reversible reaction at a cell potential less than −2.5 V.

Embodiment 18. The method of any of Embodiments 15-17, wherein the redox active molecule comprises a dibenzothiophene sulfone moiety.

Embodiment 19. The method of any of Embodiments 15-18, wherein the redox active molecule comprises a thianthrene disulfone moiety.

Embodiment 20. The method of any of Embodiments 15-19, wherein the acid comprises at least one acid selected from the group consisting of formic acid, acetic acid, benzoic acid, oxalic acid, propionic acid, phosphoric acid, ascorbic acid, citric acid, malic acid, hydrofluoric acid, and any combination thereof

To facilitate a better understanding of the present invention, the following examples of certain aspects of some embodiments are given. In no way should the following examples be read to limit, or define, the entire scope of the disclosure.

### EXAMPLES

Closed ring sulfur heterocycles are typical contaminants found in sour crude oil and particularly challenging to remove. Provided herein are methods of removing these sulfur contaminants by oxidizing them to produce valuable redox-active co-product. The generic structure of some heterocyclic redox-active molecules is provided below. The substituent groups R₁ and R₂ are chosen between hydrogen (unsubstituted), alkyl (C₁-C₁₀), alkoxy (C₁-C₁₀), halogen (fluoro, chloro, bromo, iodo) and glycolic groups. The moieties with a sulfone paired with a suitable electron donating moiety such as phenothiazine sulfone, thianthrene-5,5-dioxide and 1,4-dithiine-1,1-dioxide are predicted to be symmetric redox molecules with at least two reversible electrochemical reactions.

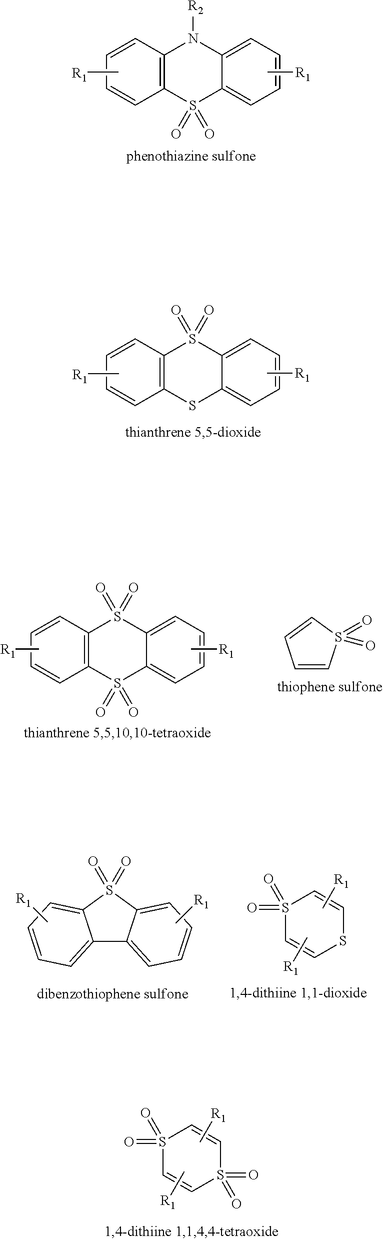

For instance, phenothiazine is oxidized by an oxidizing agent, wherein the oxidizing agent comprises hydrogen peroxide, molecular dioxygen, molecular ozone, organic oxones, potassium chlorate, potassium perchlorate, peroxydisulfuring acid, peroxymonosulfuric acid, hypochlorite, chlorite, chlorate, perchlorate and other halogen analogs, perborates, permanganate, chromate, dichromate or nitric acid, cerium (IV) containing compounds, chromium (VI) containing compounds, vanadium (V) containing compounds, or an iron (VI) containing compound. 10-hexyl-10H-phenothiazine-5,5-dioxide is synthesized as follows:

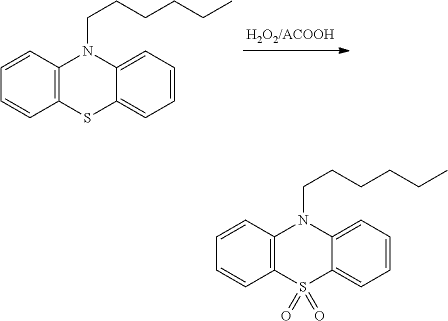 [SMILES: CCCCCCN1c2ccccc2Sc2ccccc21 ; CCCCCCN1c2ccccc2S(=O)(=O)c2ccccc21]

1.0 g (corresponding to 0.0036 mole) of 10-hexyl-10H-phenothiazine is mixed in 10 ml acetic acid. Then, 30% of aqueous hydrogen peroxide (corresponding to 6.0 g) is added in thick wall pressure glass reactor. The mixture is then heated to 80° C. for 18 hours. After cooling the mixture to ambient temperature, the solvent is diluted with 100 mL of water and white solid precipitates. The white solid cake is filtered, washed with saturated sodium bicarbonate and 20 ml hexane. The final white solid dry is then placed in a vacuum oven at 50° C. for 18 hours. A yield of ˜90% should be achieved, corresponding to 1 g of product using ¹H NMR, ¹³C NMR, and GC/MS for confirmation.

10-(2-(2-methoxyethoxy)ethyl)-10H-phenothiazine-5,5-dioxide is synthesized as follows:

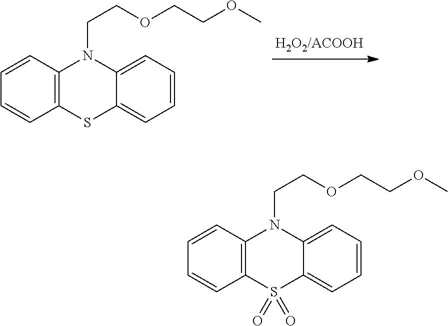 [SMILES: COCCOCCN1c2ccccc2Sc2ccccc21 ; COCCOCCN1c2ccccc2S(=O)(=O)c2ccccc21]

1.0 g, (corresponding to 0.0032 mole) of 10-[2-(2-methoxyethoxy)ethyl]-10H-phenothiazine is mixed in 10 ml acetic acid. Then, 30% of aqueous hydrogen peroxide (corresponding to 5.6 g) is added to a thick wall pressure glass reactor containing the mixture. The mixture is then heated to 80° C. for 3 hours. After cooling the mixture to ambient temperature, the solvent is diluted with 50 mL water and extracted in dichloromethane (CH₂Cl₂) forming a dichloromethane organic layer. The dichloromethane organic layer is then washed with saturated sodium bicarbonate (NaHCO₃) solution (2×30 mL) and dried with anhydrous magnesium sulfate (MgSO₄). The dichloromethane is then evaporated and dried in vacuum oven at 50° C. for 18 hours to obtain a white solid product. A yield close to ˜92% may be achieved, corresponding to 1.1 g of product using ¹H NMR, ¹³C NMR, and GC/MS for confirmation.

3,7-di-tert-butyl-10-hexyl-10H-phenothiazine 5,5-dioxide is synthesized as follows:

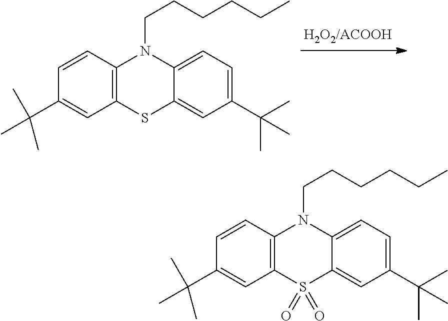

To a stirred solution of 3,7-di-tert-butyl-10-hexyl-10H-phenothiazine (2.4 g, 6.07 mmol) in DCM (25 mL), was added m-CPBA (55%, 8.90 g, 51.6 mmol) in portions at 0° C. and the solution was stirred at room temperature for 16 h. After confirming the reaction completion by TLC, the reaction mixture was quenched with 2M aq. K₂CO₃ solution (25 mL) and extracted with DCM (25 mL×3). The combined organic extract was washed with brine (25 mL), dried over anhydrous sodium sulphate, filtered and concentrated under reduced pressure to get 2.5 g crude product as a pale yellow thick liquid. The crude product was purified by flash column chromatography (silica-gel, 230-400 mesh size) using ethyl acetate in pet ether (0-4%) as an eluent to obtain the desired product 3,7-di-tert-butyl-10-hexyl-10H-phenothiazine 5,5-dioxide (900 mg, 2.032 mmol, 33.5% yield) as an off white solid.

LCMS: m/z: 428.3 (M+H)⁺, RT (min): 3.516, Area (%): 98.33.

HPLC: RT (min): 7.305, Area (%): 96.77.

¹H-NMR (400 MHZ, DMSO-d₆): δ 7.85 (d, J=2.40 Hz, 2H), 7.81 (dd, J=2.40, 8.80 Hz, 2H), 7.59 (d, J=9.20 Hz, 2H), 4.26 (t, J=7.60 Hz, 2H), 1.77-1.73 (m, 2H), 1.40-1.38 (m, 2H), 1.34 (s, 18H), 1.31-1.27 (m, 5H), 0.85 (t, J=7.20 Hz, 3H).

¹³C-NMR (100 MHZ, DMSO-d₆): 144.70, 138.71, 131.59, 122.96, 118.27, 117.31, 47.23, 34.69, 31.34, 31.30, 26.75, 25.94, 22.55, 14.30.

2-methoxythianthrene-5,5,10,10-tetraoxide is synthesized as follows:

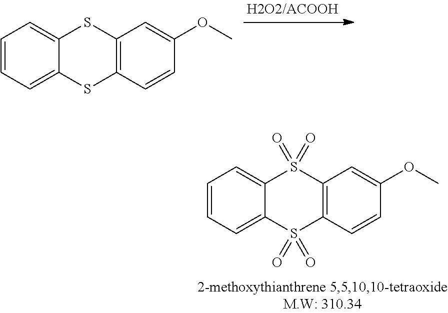 [SMILES: COc1ccc2c(c1)Sc1ccccc1S2 ; COc1ccc2c(c1)S(=O)(=O)c1ccccc1S2(=O)=O]

0.3 g of 2-methoxythianthrene is mixed in 10 ml of acetic acid. Then, 30% of aqueous hydrogen peroxide (corresponding to 2.7 g) is added to the mixture. The mixture is then heated to 80° C. for 3 hours. Cooling the mixture to ambient temperature causes precipitation of a white solid. The filtered white solid is washed with saturated sodium bicarbonate (2×30 mL), rinsed with 20 mL of hexane. The final white solid is dried in a vacuum oven at room temperature for 18 hours. A yield close to ˜53% may be achieved, corresponding to 0.2 g of product using ¹H NMR, ¹³C NMR, and GC/MS for confirmation.

1-methoxythianthrene-5,5,10,10-tetraoxide is synthesized as follows:

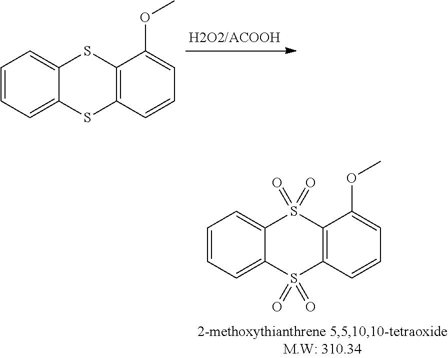 [SMILES: COc1cccc2c1Sc1ccccc1S2 ; COc1cccc2c1S(=O)(=O)c1ccccc1S2(=O)=O]

0.3 g of 1-methoxythianthrene is mixed in 10 ml of acetic acid. Then, 30% of aqueous hydrogen peroxide (corresponding to 2.7 g) is added to the mixture. The mixture is then heated to 80° C. for 3 hours. Cooling the mixture to ambient temperature causes precipitation of a white solid. The filtered white solid is washed with saturated sodium bicarbonate (2×30 mL), rinsed with 20 mL of hexane. The final white solid is dried in a vacuum oven at room temperature for 18 hours. A yield close to ˜53% may be achieved, corresponding to 0.2 g of product, using ¹H NMR, ¹³C NMR, and GC/MS for confirmation.

4,6-dibenothiophene-5,5-dioxide is synthesized as follows:

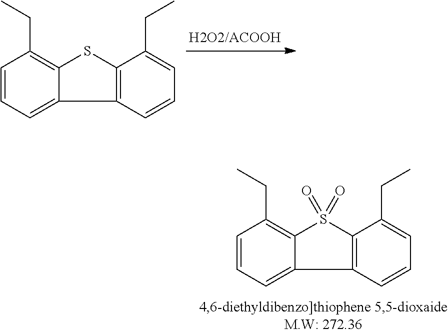 [SMILES: CCc1cccc2c1sc1c(CC)cccc12 ; CCc1cccc2c1S(=O)(=O)c1c(CC)cccc1-2]

In a thick-walled sealed glassed tube, 0.5 g of 4,6-diethyldibenzothiophene is added to 10 mL of acetic acid. Then, 30% of aqueous hydrogen peroxide (corresponding to 3.5 g) is added to the mixture. The mixture is then heated to 90° C. and stirred for 18 hours. Cooling the mixture to ambient temperature causes precipitation of a white solid. The filtered white solid is washed with saturated sodium bicarbonate (2×30 mL) and rinsed with 20 mL of hexane. The final white solid is dried in a vacuum oven at room temperature for 18 hours. A yield close to ˜70% may be achieved, corresponding to 0.4 g of product, using ¹H NMR, ¹³C NMR, and GC/MS for confirmation.

Electrochemical screening methods were used to screen the specific compounds. One type of screening method was cyclic voltammetry screening experiments performed in a nitrogen-purged 3-electrode beaker cell using 5 mM of the screened redox species, acetonitrile solvent, and 0.1 M of N-tetrabutylammonium hexafluorophosphate (TBAPF₆) as supporting electrolyte. A silver wire in 10 mM silver nitrate (AgNO₃)+0.1 M TBAPF₆ in acetonitrile with a double junction was used as the reference electrode. The reference electrode potential was measured to be −0.09 V versus a Ferrocene|Ferrocenium (Fc|Fc+) redox couple. Voltammetry data was recorded at 100 mV/s using a Princeton Applied Research Versastat MC potentiostat. Electrochemical data was corrected for solution resistance by a manual ohmic compensation of 80-130Ω as measured using electrochemical impedance spectroscopy (EIS).

Table 2 is a summary of the measured half-cell potential determined by the arithmetic average of the anode and cathode peaks in the cyclic voltammograms (FIGS. 3-7) of the compounds identified with the highest half-cell voltages:

TABLE 2
Structure and Redox Potentials of Thianthrene-based Anolytes.

| | | E^{1/2} |
|---|---|---|
| Entry | Bipolar Compound | (V) |
| 1 | 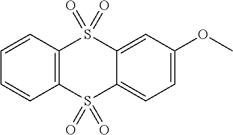 [SMILES: COc1ccc2c(c1)S(=O)(=O)c1ccccc1S2(=O)=O] | −1.796 |
| 2 | 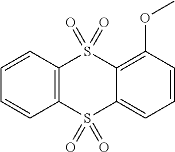 [SMILES: COc1cccc2c1S(=O)(=O)c1ccccc1S2(=O)=O] | −1.786 |
| 3 | 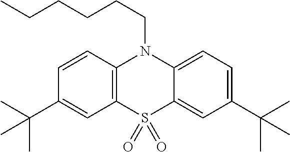 [SMILES: CCCCCCN1c2ccc(C(C)(C)C)cc2S(=O)(=O)c2cc(C(C)(C)C)ccc21] | −2.752, 1.082 |
| 4 | 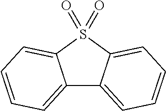 [SMILES: O=S1(=O)c2ccccc2-c2ccccc21] | −2.147 |
| 5 | 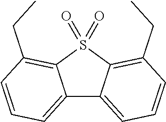 [SMILES: CCc1cccc2c1S(=O)(=O)c1c(CC)cccc1-2] | −2.223 |

Entry 1 in Table 2 is 2-methoxythianthrene-5,5,10,10-tetraoxide, which has a highly reversible anolytic reaction with redox potential, E_{1/2}, at −1.796 V as illustrated in FIG. 3 with the cyclic voltammaogram of 5 mM 2-methoxythianthrene-5,5,10,10-tetraoxide+0.1 M N-tetrabutylammonium hexafluorophosphate (TBAPF₆) in acetonitrile (100 mV/s) between +2.0 V to +0 V.

Entry 2 in Table 2 is 1-methoxythianthrene-5,5,10,10-tetraoxide with its highly reversible anolytic reaction with redox potential, E_{1/2}, at −1.786 V as well as illustrated in FIG. 4 with the cyclic voltammogram of 5 mM 2-methoxythianthrene-5,5,10,10-tetraoxide+0.1 M N-tetrabutylammonium hexafluorophosphate (TBAPF₆) in acetonitrile (100 mV/s) between +2.1 V to +0 V.

Entry 3 in Table 2 is 3,7-di-tert-butyl-10-hexyl-10H-phenothiazine 5,5-dioxide with its highly reversible catholytic reaction with a redox potential, E_{1/2}, at +2.752 V and +1.082 V as illustrated in FIG. 5 with the cyclic voltammogram of 5 mM 3,7-di-tert-butyl-10-hexyl-10H-phenothiazine 5,5-dioxide+0.1M TBAPF₆ in acetonitrile at 100 mV/s between −3.0 V to +1.25 V.

Entry 4 in Table 2 is dibenzothiophene sulfone with its highly reversible anolytic reaction with redox potential, E_{1/2}, at −2.147 V as illustrated in FIG. 6 with the cyclic voltammogram of 5 mM dibenzothiophene sulfone+0.1M TBAPF₆ in acetonitrile at 100 mV/s between −2.5 V to 0 V.

Finally, Entry 5 in Table 2 is 4,6-diethyl-dibenzo[b,d]thiophene 5,5-dioxide with its highly reversible catholytic reaction with a redox potential, E_{1/2}, at −2.223 V as illustrated in FIG. 7 with the cyclic voltammogram of 5 mM 4,6-diethyl-dibenzo[b,d]thiophene 5,5-dioxide+0.1M TBAPF₆ in acetonitrile at 100 mV/s between −2.5 V to +0 V.

While the disclosure has been described with respect to a number of embodiments and examples, those skilled in the art, having benefit of this disclosure, will appreciate that other embodiments can be devised which do not depart from the scope and spirit of the disclosure as disclosed herein. Although individual embodiments are discussed, the present disclosure covers all combinations of all those embodiments.

While compositions, methods, and processes are described herein in terms of “comprising,” “containing,” “having,” or “including” various components or steps, the compositions and methods can also “consist essentially of” or “consist of” the various components and steps. The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the disclosure, additionally, they do not exclude impurities and variances normally associated with the elements and materials used.

All numerical values within the detailed description are modified by “about” the indicated value, and take into account experimental error and variations that would be expected by a person having ordinary skill in the art.

Many alterations, modifications, and variations will be apparent to those skilled in the art in light of the foregoing description without departing from the spirit or scope of the present disclosure and that when numerical lower limits and numerical upper limits are listed herein, ranges from any lower limit to any upper limit are contemplated.

What is claimed is:

1. A system for energy storage comprising:
an electroactive redox molecule comprising an anolyte moiety comprising a multi-ring conjugated system comprising at least one sulfone group, wherein an anolyte reaction occurs at a cell potential less than −1.50 V;
a positive section comprising a first metal electrode in contact with the electroactive redox molecule and a supporting electrolyte dissolved in a solvent; and
a negative section comprising a second metal electrode in contact with the electroactive redox molecule and additional electrolyte dissolved in additional solvent.

2. The system of claim 1, wherein the anolyte moiety comprises at least one anolyte moiety selected from the group consisting of phenothiazine sulfone, dibenzothiophene sulfone, disulfones of thianthrene, and any combinations thereof.

3. The system of claim 1 or claim 2, wherein the electroactive redox molecule comprises at least two reversible redox reactions corresponding to an electrochemical unit cell potential greater than or equal to 3.0 V.

4. The system of any one of claims 1-3, wherein the electroactive redox molecule with the at least two reversible redox reactions comprises at least one electroactive redox molecule selected from the group consisting of phenothiazine-5,5-dioxide, thianthrene S-dioxide, and any combinations thereof and has an electrochemical unit cell potential greater than or equal to 3 V.

5. The system of any one of claims 1-4, wherein the electroactive redox molecule is dispersed as a non-fluid suspension or emulsion in a polar aprotic fluid, wherein the polar aprotic fluid comprises at least one polar aprotic fluid selected from the group consisting of acetonitrile, dimethoxyethane, dimethylsulfoxide, dimethylacetamide, N,N-dimethylformamide, ethylene carbonate, propylene carbonate, nitromethane, propyl sulfone, butyl sulfone, propionitrile, valeronitrile, glutaronitrile, gamma-valerolactone, gamma-butyrolactone and sulfolane, and any combination thereof.

6. The system of any one of claims 1-5, wherein a concentration of the electroactive redox molecule is at least 0.5 moles per liter of a dispersed fluid phase.

7. The system of any one of claims 1-6, wherein the positive section is separated from the negative section by a porous separator and/or an ion-selective membrane, and wherein the system further comprises:
a circulation device configured to circulate a catholyte or an anolyte from a storage tank to the positive section or the negative section,
mechanisms to provide flow of an inert gas, wherein the flow of inert gas flow forms a purge gas stream, wherein the inert gas flow comprises nitrogen or a noble gas, and
mechanisms to condense solvent vapor from the purge gas stream and reintroduce the condensed solvent into a recirculating fluid loop comprising the electroactive redox molecule.

8. The system of any one of claims 1-7, further comprising from 2 to 250 electrochemical cells to form a battery stack, wherein each of the electrochemical cells comprises a corresponding positive section comprising a catholyte and a corresponding negative section comprising an anolyte moiety comprising a sulfone group in a sulfur heterocycle compound.

9. The system of any one of claims 1-8, wherein the positive section is separated from the negative section by a porous separator and/or an ion-selective membrane, and wherein the system further comprises a circulation device configured to circulate a catholyte or an anolyte from a storage tank to the positive section or the negative section.

10. A composition comprising:
a symmetric electroactive redox molecule with at least 2 reversible reactions separated by at least 3.0 V, wherein the symmetric electroactive redox molecule comprises an anolyte moiety comprising a multi-ring conjugated system comprising at least one sulfone group; and
a supporting electrolyte dissolved in a solvent.

11. The composition of claim 10, wherein the anolyte moiety comprises at least one anolyte moiety selected from the group consisting of phenothiazine sulfone, dibenzothiophene sulfone, disulfones of thianthrene, and any combinations thereof.

12. A method for reversibly storing electrical energy in a symmetric redox flow battery with a unit cell potential equal to or greater than 3.0 V, the method comprising:
flowing a catholyte into contact with a first electrode in a positive section of the symmetric redox flow battery, wherein the catholyte comprises at least one sulfone group in a sulfur-containing heterocyclic compound, an electroactive redox molecule comprising an anolyte moiety, wherein the anolyte moiety comprises a sulfone group in a sulfur-containing heterocyclic compound, and wherein the anolyte moiety and the catholyte are present in the same cyclic system;
flowing an anolyte into contact with a second metal electrode in a negative section of the symmetric redox flow battery, wherein the negative section is separated from the positive section with an ion-transporting membrane, wherein the anolyte comprises an additional portion of an organic molecule dissolved in additional solvent; and
supplying electrical energy to a first metal electrode and the second metal electrode while an external load is not in electrical communication with the first metal electrode and the second metal electrode to charge the symmetric redox flow battery while flowing the catholyte and flowing the anolyte.

13. The method of claim 12, wherein the anolyte moiety comprises at least one anolyte moiety selected from the group consisting of phenothiazine sulfone, dibenzothiophene sulfone, disulfones of thianthrene, and any combination thereof.

14. The method of claim 12 or claim 13, further comprising discharging the symmetric redox flow battery by establishing electrical communication between the external load with the first metal electrode and the second metal electrode while flowing the catholyte and flowing the anolyte.

15. A method of synthesizing a redox active sulfone from a sulfur-containing heterocycle comprising:
reacting the sulfur-containing heterocycle with an acid and an oxidizing agent to form products comprising an oxidized sulfone, wherein the oxidizing agent comprises at least one oxidizing agent selected from the group consisting of aqueous hydrogen peroxide, oxygen, ozone, oxones, potassium chlorate, potassium perchlorate, peroxydisulfuring acid, peroxymonosulfuric acid, hypochlorite, chlorite, chlorate, perchlorate and other halogen analogs, perborates, permanganate, chromate, dichromate or nitric acid, cerium (IV) containing compounds, chromium (VI) containing compounds, vanadium (V) containing compounds, an iron (VI) containing compound, and any combinations thereof; and
separating the products from unreacted portions of the acid and the oxidizing agent, wherein the products comprising the oxidized sulfone is a redox-active molecule with at least one electrochemically reversible reaction at a cell potential less than −1.5 V.

16. The method of claim 15, wherein the sulfur-containing heterocycle comprises a phenothiazine moiety and the products have two reversible electrochemical reactions separated by a cell potential greater than or equal to 3.0 V.

17. The method of claim 15 or claim 16, wherein the redox active sulfone has at least one electrochemically reversible reaction at a cell potential less than −2.5 V.

18. The method of any one of claims 15-17, wherein the redox active sulfone comprises a dibenzothiophene sulfone moiety.

19. The method of any one of claims 15-18, wherein the redox active sulfone comprises a thianthrene disulfone moiety.

20. The method of any one of claims 15-19, wherein the acid comprises at least one acid selected from the group consisting of formic acid, acetic acid, benzoic acid, oxalic acid, propionic acid, phosphoric acid, ascorbic acid, citric acid, malic acid, hydrofluoric acid, and any combination thereof.
